(19) United States
(12) Patent Application Publication
(10) Pub. No.: US 2026/0270789 A1
(43) Pub. Date: Sep. 10, 2026

(54) SHARING ACCESS POINT, SHARED ACCESS POINT AND TERMINAL

(71) Applicant: NTT, Inc., Tokyo (JP)

(72) Inventors: Hanae OTANI, Musashino-shi (JP); Akira KISHIDA, Musashino-shi (JP); Kengo NAGATA, Musashino-shi (JP); Hirantha ABEYSEKERA, Musashino-shi (JP); Yusuke ASAI, Musashino-shi (JP); Yasushi TAKATORI, Musashino-shi (JP)

(73) Assignee: NTT, Inc., Tokyo (JP)

(21) Appl. No.: 19/489,282

(22) PCT Filed: Jun. 14, 2023
(86) PCT No.: PCT/JP2023/022136

§ 371 Date: Dec. 2, 2025

(51) Int. Cl. H04W 28/16; H04W 88/08

(52) U.S. Cl. CPC H04W 28/16; H04W 88/08

(57) ABSTRACT

In a sharing access point according to an embodiment, in a state in which one or more shared access points are a common connection destination of wireless connection of a plurality of terminals, a management unit allocates a transfer period in which only a single target terminal group performs data transfer with a shared access point which is a common connection destination, to a plurality of terminals grouped into a plurality of terminal groups for each terminal group.

### TECHNICAL FIELD

An embodiment relates to a sharing access point, a shared access point and a terminal.

### BACKGROUND ART

A wireless local area network (LAN) is known as a system that wirelessly connects an access point (AP) and a terminal. In the wireless LAN, the terminal and the AP are wirelessly connected by association processing.

In addition, in IEEE802.11be being formulated as a successor standard of IEEE802.11ax, a terminal establishes a plurality of links with an AP, and can perform data transfer (transmission and reception of data) with the AP via each of the plurality of links. In addition, in a terminal that performs wireless communication via a plurality of links, one terminal can be wirelessly connected to a plurality of APs by wirelessly connecting a plurality of links from the terminal to different APs.

In a case where there are a plurality of terminals that perform communication via a plurality of links in an environment in which a plurality of APs are used, a state in which one or more APs are a common connection destination of wireless connections of the plurality of terminals may occur. In a state in which one or more APs are a common connection destination of a plurality of terminals, it is required to suppress a decrease in throughput and an increase in data transmission time.

### CITATION LIST

### Non Patent Literature

Non Patent Literature 1: IEEE 802. 11be D 3 . 0, “35.3 Multi-link operation”, p 479-p586, January 2023

### SUMMARY OF INVENTION

### Technical Problem

An object of the present invention is to provide a sharing access point, a shared access point, and a terminal that appropriately suppress a decrease in throughput or the like in a state in which one or more APs are a common connection destination of wireless connection of a plurality of terminals.

### Solution to Problem

In an embodiment of the present invention, a sharing access point includes a management unit, and in a state in which one or more shared access points are a common connection destination of wireless connection of a plurality of terminals, the management unit allocates a transfer period in which only a single target terminal group performs data transfer with a shared access point which is a common connection destination, to a plurality of terminals grouped into a plurality of terminal groups for each terminal group.

### Advantageous Effects of Invention

According to the present invention, it is possible to provide a sharing access point, a shared access point, and a terminal that appropriately suppress a decrease in throughput or the like in a state in which one or more APs are a common connection destination of wireless connection of a plurality of terminals.

### Brief Description of Drawings

FIG. 1 is a block diagram illustrating an example of a configuration of a communication system according to an embodiment.

FIG. 2 is a block diagram illustrating an example of a hardware configuration of a sharing AP according to the embodiment.

FIG. 3 is a block diagram illustrating an example of a hardware configuration of a shared AP according to the embodiment.

FIG. 4 is a block diagram illustrating an example of a hardware configuration of a terminal according to the embodiment.

FIG. 5 is a block diagram illustrating an example of a functional configuration of the sharing AP according to the embodiment.

FIG. 6 is a block diagram illustrating an example of a functional configuration of the shared AP according to the embodiment.

FIG. 7 is a block diagram illustrating an example of a functional configuration of the terminal according to the embodiment.

FIG. 8 is a sequence diagram illustrating an example of allocation of transfer periods to a plurality of terminals in the communication system according to the embodiment.

FIG. 9 is a flowchart illustrating an example of processing performed by the communication system according to the embodiment.

### DESCRIPTION OF EMBODIMENTS

Hereinafter, an embodiment will be described with reference to the drawings. Note that in the following description, components having the same function and configuration are denoted by the same reference numerals.

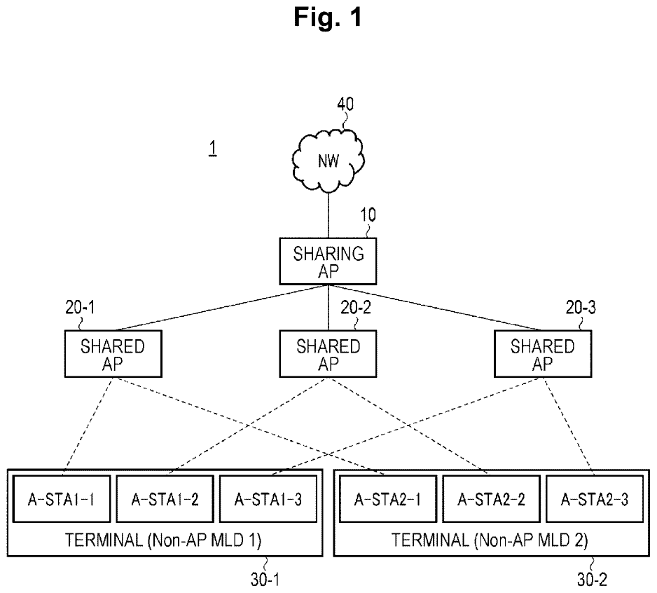

FIG. 1 is a block diagram illustrating an example of a configuration of a communication system according to an embodiment. As illustrated in FIG. 1, a communication system 1 includes a sharing access point (AP) 10, shared APs 20-1, 20-2, and 20-3, and terminals 30-1 and 30-2. The sharing AP 10 is connected to a network 40.

The sharing AP 10 is, for example, an access point (AP) of a wireless LAN. The sharing AP 10 is configured to perform wired communication or wireless communication with a server (not illustrated) on the network 40. The sharing AP 10 is configured to perform wireless communication or wired communication with each of the shared APs 20-1 to 20-3.

Each of the shared APs 20-1 to 20-3 is, for example, an access point (AP) of the wireless LAN. The shared APs 20-1 to 20-3 are respectively installed at positions physically separated from one another, and the shared APs 20-1 to 20-3 have communicable areas that are different from one another. In the example of FIG. 1, at least a part of the communicable area of each of the shared APs 20-1 to 20-3 overlaps the communicable area of other shared APs. Each of the shared APs 20-1 to 20-3 is configured to perform the wireless communication with each of the terminals 30-1 and 30-2. Each of the shared APs 20-1 to 20-3 performs communication with each of the terminals 30-1 and 30-2, for example, in accordance with the IEEE802.11 standard. Note that the shared APs 20-1 to 20-3 have Configurations equivalent to one another. Hereinafter, the Shared APs 20-1 to 20-3 may be described as the shared AP(s) 20 unless otherwise distinguished.

Each of the terminals 30-1 and 30-2 is a wireless terminal such as a smartphone and a personal computer (PC). In the example of FIG. 1, each of the terminals 30-1 and 30-2 is located in a communicable area capable of Communicating with all of the shared APs 20-1 to 20-3. That is, the plurality of APs 20-1 to 20-3 are a common connection destination of wireless connections of the plurality of terminals 30-1 and 30-2. Each of the terminals 30-1 and 30-2 is configured to communicate with a Server on the network 40 by communicating with the sharing AP 10 via at least one of the shared APs 20-1 to 20-3. That is, each of the terminals 30-1 and 30-2 is connected to the sharing AP 10 via at least one of the shared APs 20-1 to 20-3. The connection method between each of the terminals 30-1 and 30-2 and the sharing AP 10 as described above is also referred to as a “multi-AP connection method”. The terminals 30-1 and 30-2 have configurations equivalent to each other. Hereinafter, the terminals 30-1 and 30-2 may be described as the terminal(s) 30 unless Otherwise distinguished.

Further, each of the terminals 30 is a wireless terminal that performs wireless communication using a plurality of channels (links). Each of the terminals 30 Corresponds to a non-AP MLD and includes a plurality of affiliated stations (STAS). In an example in FIG. 1, each of the terminals 30 includes three affiliated STAs. The terminal 30-1 is also referred to as a non-AP MLD 1, and includes A-STA1-1, A-STA1-2, and A-STA1-3 as three affiliated STAs. The terminal 30-2 is also referred to as a non-AP MLD 2, and includes A-STA2-1, A-STA2-2, and A-STA2-3 as three affiliated STAs.

Each of the terminals 30 (non-AP MLDs) is a multi-link device (MLD) on the terminal 30 side that manages the state of a link established by each of a plurality of Subordinate affiliated STAs. Each of the terminals 30 also performs processing for establishing connection with the sharing AP 10 in the multi-AP connection method.

In the multi-AP connection method in which three shared APs 20-1 to 20-3 are provided as the example of FIG. 1, the sharing AP 10 can establish each of connection (transfer path) via the shared AP 20-1, connection (transfer path) via the shared AP 20-2, and connection (transfer path) via the shared AP 20-3 with each of the terminals 30 (non-AP MLDs). In other words, each of the shared APs 20-1 to 20-3 is a candidate for a via-destination in data exchange between the sharing AP 10 and each of the terminals 30. Then, each of the A-STA 1-1 to A-STA 1-3 of the terminal 30-1 and the A-STA 2-1 to A-STA 2-3 of the terminal 30-2 executes data exchange with the Sharing AP 10 via one of the shared APs 20-1 to 20-3 that are candidates for a via-destination.

In the example of FIG. 1, in the data exchange between the sharing AP 10 and the terminal 30-1 (non-AP MLD 1), the link established between the A-STA 1-1 and the Shared AP 20-1, the link established between the A-STA 1-2 and the shared AP 20-2 and the link established between the A-STA 1-3 and the shared AP 20-3 are used. In the data exchange between the sharing AP 10 and the terminal 30-2 (non-AP MLD 2), the link established between the A-STA 2-1 and the shared AP 20-1, the link established between the A-STA 2-2 and the shared AP 20-2 and the link established between the A-STA 2-3 and the shared AP 20-3 are used.

Therefore, each of the terminals 30 is wirelessly connected to a plurality of shared APs 20 by a plurality of affiliated STAS. Note that, in the following description, the shared APs 20-1 to 20-3 are also referred to as access points “belonging” to the sharing AP 10 in the multi-AP connection method.

The sharing AP 10, the shared APs 20-1 to 20-3, and the terminals 30-1 and 30-2 have, for example, a wireless communication function based on an open systems interconnection (OSI) reference model. In the OSI reference model, the wireless communication function is divided into seven layers (a first layer: a physical layer, a second layer: a data link layer, a third layer: a network layer, a fourth layer: a transport layer, a fifth layer: a session layer, a sixth layer: a presentation layer, and a Seventh layer: an application layer). The data link layer includes a logical link control (LLC) sublayer and a media access control (MAC) sublayer.

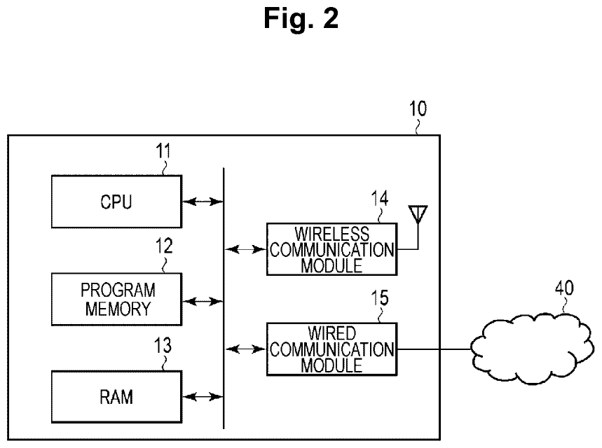

FIG. 2 is a block diagram illustrating an example of a hardware configuration of the sharing AP according to the embodiment. FIG. 2 illustrates an example of a case where the sharing AP 10 performs the wireless communication with each of the shared APs 20. As illustrated in FIG. 2, the sharing AP 10 includes, for example, a central processing unit (CPU) 11, a read only memory (ROM) 12, a random access memory (RAM) 13, a wireless communication module 14, and a wired communication module 15.

The CPU 11 is a processing circuit that controls an entire operation of the sharing AP 10. The ROM 12 is a nonvolatile semiconductor memory, for example. The ROM 12 stores a program for controlling the sharing AP 10, and data. The RAM 13 is, for example, a volatile semiconductor memory. The RAM 13 is used as a working area of the CPU 11. The wireless communication module 14 is a circuit used to transmit and receive data with a wireless signal. The wireless communication module 14 is connected to an antenna. The wired communication module 15 is a circuit used to transmit and receive data with a wired signal. The wireless communication module 14 can be connected (wirelessly connected) to the shared APs 20-1 to 20-3. The wired communication module 15 is connected to the network 40.

Note that, in a case where the sharing AP 10 performs the wired communication with each of the shared APs 20, the wireless communication module 14 is not provided in the sharing AP 10. In this case, the wired Communication module 15 can be connected to the network 40 and can be connected (wired-connected) to the shared APs 20-1 to 20-3.

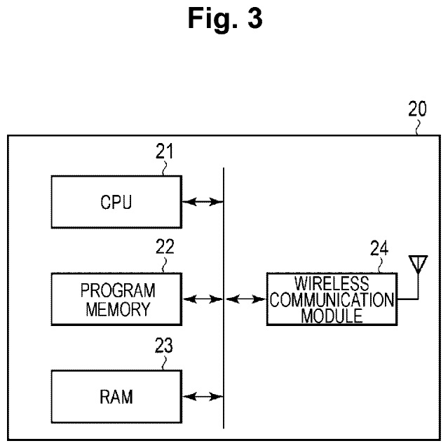

FIG. 3 is a block diagram illustrating an example of a hardware configuration of the shared AP according to the embodiment. FIG. 3 illustrates an example of a case where the shared AP 20 performs the wireless communication with the sharing AP 10. As illustrated in FIG. 3, the shared AP 20 includes, for example, a CPU 21, a ROM 22, a RAM 23, and a wireless communication module 24.

The CPU 21 is a processing circuit that controls the entire operation of the shared AP 20. The ROM 22 is a nonvolatile semiconductor memory, for example. The ROM 22 stores a program for controlling the shared AP 20, and data. The RAM 23 is, for example, a volatile semiconductor memory. The RAM 23 is used as a working area of the CPU 21. The wireless communication module 24 is a circuit used to transmit and receive data with a wireless signal. The wireless communication module 24 is connected with an antenna. The wireless communication module 24 can be connected (wirelessly connected) to the sharing AP 10 and the terminals 30-1 and 30-2.

Note that, in a case where the shared AP 20 performs the wired communication with the sharing AP 10, a wired communication module (not illustrated) is further provided in the shared AP. In this case, the wireless communication module 24 can be connected to the terminals 30-1 and 30-2, and the wired communication module can be connected (wired connected to the sharing AP 10.

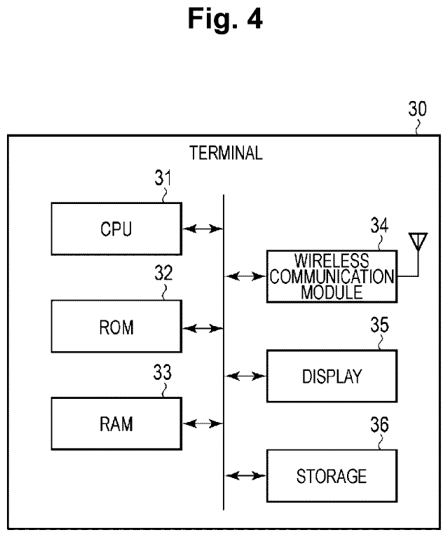

FIG. 4 is a block diagram illustrating an example of a hardware configuration of the terminal according to the embodiment. As illustrated in FIG. 4, the terminal 30 includes, for example, a CPU 31, a ROM 32, a RAM 33, a wireless communication module 34, a display 35, and a storage 36.

The CPU 31 is a processing circuit that controls an entire operation of the terminal 30. The ROM 32 is a nonvolatile semiconductor memory, for example. The ROM 32 stores a program for controlling the terminal 30, and data. The RAM 33 is, for example, a volatile semiconductor memory. The RAM 33 is used as a working area of the CPU 31. The wireless communication module 34 is a circuit used to transmit and receive data with a wireless signal. The wireless communication module 34 is connected with an antenna. The display 35 is, for example, a liquid crystal display (LCD) or an electro luminescence (EL) display. The display 35 displays a graphical user interface (GUI) corresponding to application software, or the like. The storage 36 is a nonvolatile storage device. The storage 36 stores system software of the terminal 30, and the like.

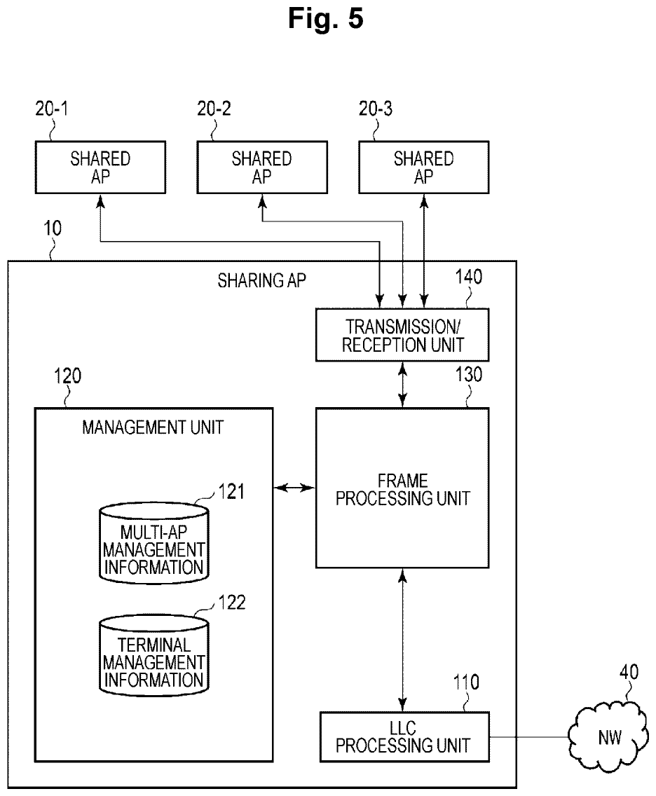

FIG. 5 is a block diagram illustrating an example of a functional configuration of the sharing AP according to the embodiment. As illustrated in FIG. 5, the sharing AP 10 functions as a computer including an LLC processing unit 110, a management unit 120, a frame processing unit 130, and a transmission/reception unit 140. The LLC processing unit 110 is a functional block that executes processing Corresponding to the LLC sublayer of the second layer and the third layer to the seventh layer. The management unit 120 and the frame processing unit 130 are functional blocks that execute processing corresponding to the MAC sublayer of the second layer. Furthermore, in the case where the sharing AP 10 performs the wireless communication with each of the shared APs 20, the transmission/reception unit 140 is a functional block that executes processing Corresponding to the first layer.

The LLC processing unit 110 that functions also as a data processing unit adds, for example, a destination service access point (DSAP) header, a source service access point (SSAP) header, and the like to the data received from the network 40 to generate an LLC packet. Then, the LLC processing unit 110 inputs the generated LLC packet to the frame processing unit 130. In addition, the LLC processing unit 110 extracts data from the LLC packet input from the frame processing unit 130. Then, the LLC processing unit 110 transmits the extracted data to the network 40.

The management unit 120 controls establishment of the connection (logical wireless connection) between the sharing AP 10 and each of the terminals 30 (non-AP MLDs) in the multi-AP connection method. In the multi-AP connection method, data exchange is performed between the sharing AP 10 and each of the terminals 30 in a state where each of the affiliated STAs in each of the terminals 30-1 and 30-2 is wirelessly connected to any one of the shared APs 20-1 to 20-3. The management unit 120 controls establishment of wireless connection between each of a plurality of affiliated STAs and the corresponding shared AP 20 for each of the terminals 30. A wireless connection (link) between each of the affiliated STAs and the corresponding shared AP 20 is established, for example, by association processing.

In addition, the management unit 120 stores multi-AP management information 121 and terminal management information 122. The multi-AP management information 121 includes information regarding the access points (that is, the sharing AP 10 and the shared APs 20-1 to 20-3) used for the multi-AP connection method. The information regarding the access points used for the multi-AP connection method includes, for example, an identifier, a frequency band, operation parameters, and the like.

The identifier is, for example, an identifier of a Corresponding AP. The identifier may include a MAC address of the corresponding AP. The frequency band includes information indicating a frequency band used by the corresponding AP in the multi-AP connection method. As the frequency band, for example, a 2.4 GHz band, a 5 GHz band, a 6 GHz band, a 45 GHz band, a 60 GHz band, or the like can be applied. Each frequency band may include a plurality of channels. In this case, the multi-AP management information 121 may include channel information instead of or in addition to the frequency band information.

The operation parameter includes, for example, CWmin, CWmax, an arbitration interframe space (AIFS), and a transmission opportunity (TXOP) Limit. The CWmin and the CWmax indicate a minimum value and a maximum value of a contention window, respectively. The contention window is a parameter used to calculate backoff that is a transmission wait time for collision avoidance. The AIFS is a fixed transmission wait time set for each traffic access category. The traffic access categories include, for example, “voice (VO) ”, “video (VI)”, “best effort (BE) ”, “background (BK) ”, and “low latency (LL)”. The TXOP Limit indicates an upper limit value of a channel occupancy period TXOP.

The terminal management information 122 stores information regarding the terminal 30 (for example, the terminals 30-1 and 30-2) connected to the sharing AP 10 by the multi-AP connection method. Specifically, the terminal management information 122 includes an identifier of the terminal 30 (non-AP MLD) and respective identifiers of the affiliated STA of the terminal 30 and the shared AP 20 passed through in the connection with the terminal 30. The identifier of the terminal 30 (non-AP MLD) may include a MAC address of the non-AP MLD. Furthermore, the identifier of the affiliated STA passed through in the connection with the terminal 30 may include a MAC address of the affiliated STA, and the identifier of the shared AP 20 passed through in the connection with the terminal 30 may include the MAC address of the shared AP 20.

Data from the LLC processing unit 110 is input to the frame processing unit 130 as an LLC packet. In the Case where the sharing AP 10 performs the wireless communication with each of the shared APs 20, the frame processing unit 130 adds a MAC header to the LLC packet input from the LLC processing unit 110 to generate a MAC frame. Then, the frame processing unit 130 outputs the generated MAC frame to the transmission/reception unit 140. Furthermore, in the case where the sharing AP 10 performs the wireless communication with each of the shared APs 20, the frame processing unit 130 extracts the LLC packet from the MAC frame input from the transmission/reception unit 140. Then, the frame processing unit 130 outputs the extracted LLC packet to the LLC processing unit 110. Note that, in the following description, the MAC frame including data is also referred to as a “data frame”.

In a case where the sharing AP 10 performs the wired communication with each of the shared APs 20, the frame processing unit 130 outputs the LLC packet input from the LLC processing unit 110 to the transmission/reception unit 140. Further, the frame processing unit 130 outputs the LLC packet input from the transmission/reception unit 140 to the LLC processing unit 110.

Further, management information is input from the management unit 120 to the frame processing unit 130, and the frame processing unit 130 outputs the management information from the management unit 120 to the transmission/reception unit 140. The management information includes notification information to be notified to any of the shared AP 20 and the terminal 30, control information regarding control of operation of any of the shared AP 20 or the terminal 30, and the like. In addition, the management information can include the multi-AP management information 121 and the terminal management information 122 described above. In the case where the Sharing AP 10 performs the wireless communication with each of the shared APs 20, the frame processing unit 130 generates a management frame that is a MAC frame including the management information from the management unit 120, and outputs the generated management frame to the transmission/reception unit 140.

Furthermore, data and the management information are input from the transmission/reception unit 140 to the frame processing unit 130. The management information input from the transmission/reception unit 140 includes the notification information notified from any of the shared AP 20 and the terminal 30, and the like. In a case where data is input from the transmission/reception unit 140 as a data frame or an LLC packet, the frame processing unit 130 outputs the input data to the LLC processing unit 110.

Further, in the case where the management information is input from the transmission/reception unit 140, the frame processing unit 130 outputs the input notification information and the like to the management unit 120. In the case where the sharing AP 10 performs the wireless Communication with each of the shared APs 20, the management frame that is a MAC frame including the management information is input from the transmission/reception unit 140 to the frame processing unit 130, and the frame processing unit 130 outputs the management information included in the management frame from the transmission/reception unit 140 to the management unit 120.

The transmission/reception unit 140 transmits and receives the data, the management information, and the like to and from each of the belonging shared APs 20 by the wireless communication or the wired communication. In the case where the sharing AP 10 performs the wireless Communication with each of the shared APs 20, the transmission/reception unit 140 includes one or more wireless signal processing units. Then, each of the wireless signal processing units of the transmission/reception unit 140 adds a preamble or the like to the MAC frame (the data frame, the management frame, and the like) input from the frame processing unit 130 to generate a wireless frame, and converts the generated wireless frame into a wireless signal. Then, each of the wireless signal processing units transmits (radiates) the converted wireless signal via an antenna. Conversion processing from the wireless frame to the wireless signal includes, for example, convolutional encoding processing, interleave processing, subcarrier modulation processing, inverse fast Fourier transform processing, OFDM modulation processing, and frequency conversion processing.

Each of the wireless signal processing units of the transmission/reception unit 140 converts the wireless signal received from any of the shared APs 20 via an antenna into the wireless frame. Conversion processing from the wireless signal to the wireless frame includes, for example, frequency conversion processing, OFDM demodulation processing, fast Fourier transform processing, subcarrier demodulation processing, deinterleave processing, and Viterbi decoding processing. Each of the wireless signal processing units extracts the MAC frame from the converted wireless frame, and outputs the extracted MAC frame to the frame processing unit 130.

In one example, the same number of wireless signal processing units as the belonging shared AP 20 are provided in the transmission/reception unit 140, and one corresponding wireless signal processing unit is provided for each of the plurality of shared APs. Then, data and the like are input from the frame processing unit 130 to the wireless signal processing unit corresponding to the Shared AP 20 which is the transmission destination. Note that, in a case where a plurality of wireless signal processing units is provided in the transmission/reception unit 140 as in the above-described example, the plurality of wireless signal processing units is configured to transmit and receive the wireless signals to and from by using frequency bands or channels different from one another.

In the case where the sharing AP 10 performs the wired communication with each of the shared APs 20, the transmission/reception unit 140 is connected to each of the belonging shared APs 20 via a wired network, and transmits and receives data, the management information, and the like to and from each of the shared APs 20 via the wired network. In this case, the transmission/reception unit 140 includes a network interface of the wired network.

The management unit 120 performs allocation (mapping) of traffic transmitted and received between the sharing AP 10 and the terminal 30 in cooperation with the belonging shared APs 20 and the terminal 30 (non-AP MLD).

As a result, the traffic such as data transmitted from the sharing AP 10 is allocated to the belonging shared APs 20. The management unit 120 instructs the frame processing unit 130 to transmission destination of the traffic on the basis of an allocation result for the traffic. Then, the frame processing unit 130 causes to transmit the traffic from the transmission/reception unit 140 to the shared AP 20 Corresponding to the instruction from the management unit 120. Note that the management unit 120 may allocate the traffic on the basis of a traffic identifier (TID) associated with the access category.

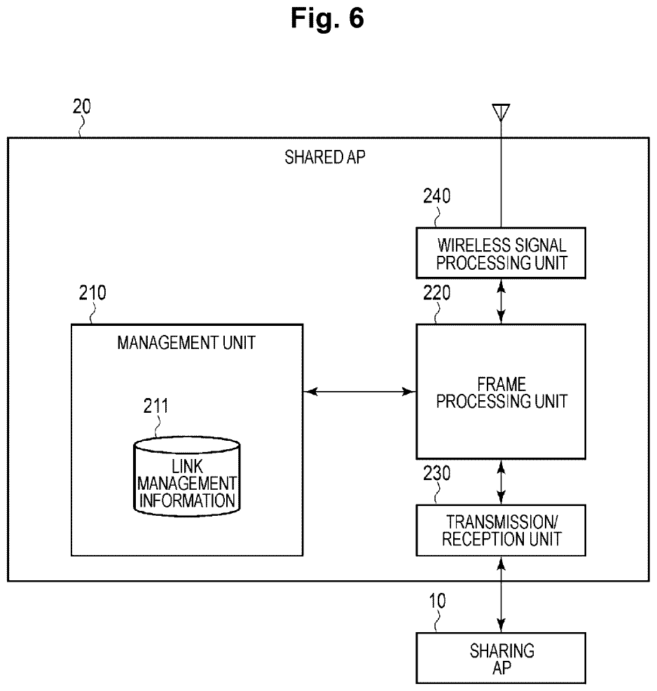

FIG. 6 is a block diagram illustrating an example of a functional configuration of the shared AP according to the embodiment. The shared AP 20 functions as a computer including a management unit 210, a frame processing unit 220, a transmission/reception unit 230, and wireless signal processing units 240. The management unit 210 and the frame processing unit 220 are functional blocks that execute processing corresponding to the MAC sublayer of the second layer. The wireless signal processing unit 240 is a functional block that executes processing corresponding to the first layer. Furthermore, in the case where the Sharing AP 10 performs the wireless communication with each of the shared APs 20, the transmission/reception unit 230 serves as the functional block that executes the processing Corresponding to the first layer, and in the case where the sharing AP 10 performs the wired communication with each of the shared APs 20, the transmission/reception unit 230 serves as the functional block that executes the processing Corresponding to the MAC sublayer of the second layer.

The transmission/reception unit 230 transmits and receives the data, the management information, and the like to and from the sharing AP 10 by the wireless communication or the wired communication. In the case where the shared AP 20 performs the wireless communication with the sharing AP 10, the transmission/reception unit 230 includes a wireless signal processing unit. Then, the wireless signal processing unit of the transmission/reception unit 230 adds a preamble and the like to the MAC frame (the data frame, the management frame, and the like) input from the frame processing unit 220 to generate a wireless frame. Then, the wireless signal processing unit of the transmission/reception unit 230 converts the generated wireless frame into a wireless signal, and transmits (radiates) the converted wireless signal to the sharing AP 10 via an antenna. Conversion processing from the wireless frame into the wireless signal is performed as described above.

Furthermore, the wireless signal processing unit of the transmission/reception unit 230 converts the wireless signal received from the sharing AP 10 via an antenna into the wireless frame. Conversion processing from the wireless signal into the wireless frame is performed as described above. The wireless signal processing unit extracts a MAC frame from the converted wireless frame, and outputs the extracted MAC frame to the frame processing unit 220.

In the case where the shared AP 20 performs the wired communication with the sharing AP 10, the transmission/reception unit 230 is connected to the sharing AP 10 via the wired network, and transmits and receives the data, the management information, and the like to and from the sharing AP 10 via the wired network. In this case, the transmission/reception unit 230 includes a network interface of the wired network.

In the case where the shared AP 20 performs the wired communication with the sharing AP 10, the frame processing unit 220 generates a MAC frame including the data, the management information, or the like received by the transmission/reception unit 230 from the sharing AP 10. The frame processing unit 220 adds a MAC header to the LLC packet received from the sharing AP 10 to generate the MAC frame (data frame). Furthermore, in the case where the shared AP 20 performs the wired communication with the sharing AP 10, in a case where the data frame to serve as the MAC frame is input from the wireless signal processing unit 240, the frame processing unit 220 extracts the LLC packet from the input data frame, and outputs the extracted LLC packet to the transmission/reception unit 230. Further, the frame processing unit 220 outputs the management information from the management unit 210 to the transmission/reception unit 230. Then, the transmission/reception unit 230 transmits the LLC packet, the management information, and the like to the sharing AP 10 by the wired communication.

The wireless signal processing unit 240 can transmit and receive the data, the management information, and the like to and from the wirelessly connected terminal 30 by the wireless communication. Therefore, the wireless signal processing units 240 of the shared AP 20 can establish the wireless connection with each of the terminals 30 via any one or more of the plurality of links from this terminal 30. Then, the wireless signal processing unit 240 adds a preamble and the like to the MAC frame (the data frame, the management frame, and the like) input from the frame processing unit 220 to generate a wireless frame. Then, the wireless signal processing unit 240 converts the generated wireless frame into a wireless signal, and transmits (radiates) the converted wireless signal to the Corresponding terminal 30 via the antenna. Conversion processing from the wireless frame into the wireless signal is performed as described above.

Further, the wireless signal processing units 240 converts a wireless signal received from the terminal 30 via the antenna into a wireless frame. Conversion processing from the wireless signal into the wireless frame is performed as described above. The wireless signal processing unit 240 extracts a MAC frame from the converted wireless frame, and outputs the extracted MAC frame to the frame processing unit 220.

In the case where the shared AP 20 performs the wireless communication with the sharing AP 10, the wireless signal processing unit of the transmission/reception unit 230 is favorably configured to perform transmission and reception using a frequency band or a channel different from the wireless signal processing unit 240. Furthermore, in the case where the shared AP 20 performs the wireless Communication with the sharing AP 10, the transmission/reception unit 230 including the wireless signal processing unit may not be provided. In this case, the shared AP 20 performs the wireless communication with the sharing AP 10 via the wireless signal processing unit 240.

The frame processing unit 220 outputs the data frame, which is the MAC frame, to the wireless signal processing unit 240. In a case where the management information is input from any one of the transmission/reception unit 230 and the wireless signal processing unit 240, the frame processing unit 220 outputs the input management information to the management unit 210. Further, in a case where the management information to be notified to the sharing AP 10 is input from the management unit 210, the frame processing unit 220 outputs the input management information to the transmission/reception unit 230. In a case where the management information to be notified to the terminal 30 is input from the management unit 210, the frame processing unit 220 generates a beacon frame as a management frame from the input management information. Then, the frame processing unit 220 outputs the generated beacon frame to the wireless signal processing unit 240. Then, the wireless signal obtained by converting the beacon frame is transmitted from the wireless signal processing unit 240, whereby the management information included in the beacon is notified to the terminal 30.

The management information notified from the shared AP 20 with the beacon includes information regarding the Sharing AP 10, information regarding the shared AP 20 of Own station, and information regarding the shared AP 20 of another station belonging to the sharing AP 10. Further, the shared AP 20 may receive the multi-AP management information 121, the terminal management information 122, and the like from the sharing AP 10, and the management unit 210 may notify the multi-AP management information 121, the terminal management information 122, and the like with the beacon.

Furthermore, the management unit 210 stores link management information 211 which is connection management information as the management information regarding the wireless connection of the terminal 30 in the multi-AP connection method. The link management information 211 includes an identifier of the terminal 30 wirelessly connected to the shared AP 20 of the own station. Then, regarding the terminal 30 wirelessly connected to the own shared AP 20, the identifier of the affiliated STA wirelessly connected to the own shared AP 20 is indicated in the link management information 211. The identifier of the terminal 30 may include the MAC address of the terminal 30, and the identifier of the affiliated STA may include the identifier of the affiliated STA.

In addition, the transmission/reception unit 230 receives an instruction related to transfer of traffic (data) with the terminal 30 wirelessly connected to own station from the sharing AP 10. The management unit 210 controls data transfer (transmission/reception of data) with the terminal 30 wirelessly connected to the shared AP 20 of its own station in accordance with an instruction from the sharing AP 10.

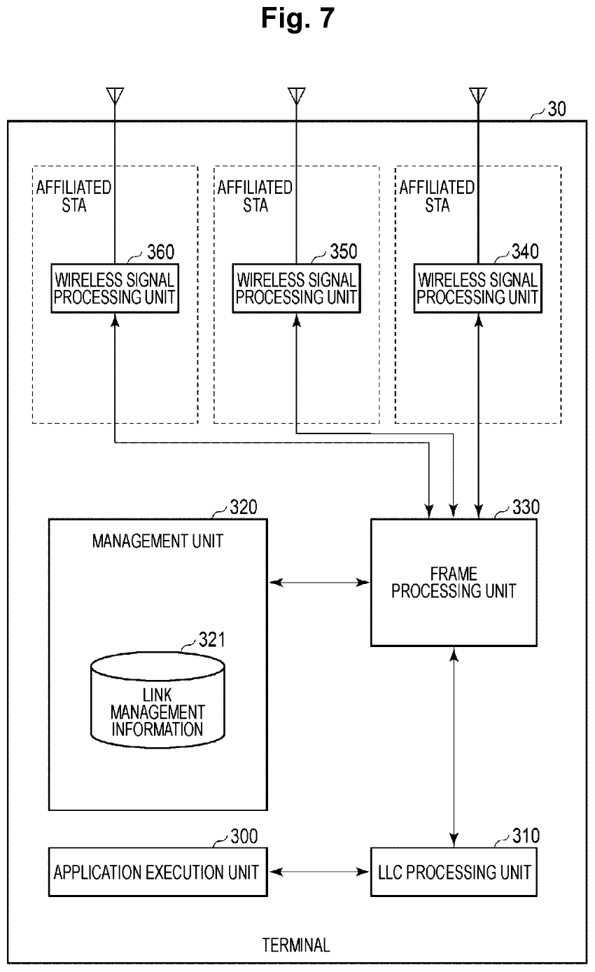

FIG. 7 is a block diagram illustrating an example of a functional configuration of the terminal according to the embodiment. The terminal 30 functions as a computer including an application execution unit 300, an LLC processing unit 310, a management unit 320, a frame processing unit 330, and wireless signal processing units 340, 350, and 360. The application execution unit 300 is a functional block that executes processing corresponding to the seventh layer. The LLC processing unit 310 is a functional block that executes processing corresponding to the LLC sublayer of the second layer and the third layer to the sixth layer. The management unit 320 and the frame processing unit 330 are functional blocks that execute processing corresponding to the MAC sublayer of the second layer. Each of the wireless signal processing units 340, 350, 360 is a functional block that executes processing corresponding to the MAC sublayer of the second layer and the first layer.

The application execution unit 300 executes an application on the basis of data input from the LLC processing unit 310. In addition, the application execution unit 300 inputs data to the LLC processing unit 310. For example, the application execution unit 300 can display application information on the display 35. Further, the application execution unit 300 can operate on the basis of operation of an input interface.

The LLC processing unit 310 that also functions as a data processing unit adds a DSAP header, an SSAP header, and the like to the data input from the application execution unit 300 to generate an LLC packet. Then, the LLC processing unit 310 outputs the generated LLC packet to the frame processing unit 330. In addition, the LLC processing unit 310 extracts data from the LLC packet input from the frame processing unit 330. Then, the LLC processing unit 310 outputs the extracted data to the application execution unit 300.

The management unit 320 controls the connection (logical wireless connection) between the sharing AP 10 and the terminal 30 (non-AP MLD) of own station in the multi-AP connection method. The terminal 30 receives the beacon from the wirelessly connected shared AP 20, so that the management unit 320 acquires the management information included in the beacon. In one example, when the terminal 30 receives the beacon from the shared AP 20, the management unit 320 acquires the multi-AP management information 121, the terminal management information 122, and the like. The management unit 320 manages the management information included in the beacon. The management unit 320 controls wireless connection between each of a plurality of affiliated STAs and the shared AP 20 which is connection destination on the basis of the management information.

The management unit 320 stores link management information 321 which is connection management information. The link management information 321 indicates an identifier Of the shared AP 20 which is a connection destination of wireless connection for each of a plurality of affiliated STAs of the terminal 30 of the own station. The identifier Of the shared AP 20 may include the MAC address of the shared AP 20.

The frame processing unit 330 adds a MAC header to the LLC packet input from the LLC processing unit 310 to generate a MAC frame. Then, the frame processing unit 330 distributes the generated MAC frame to the wireless signal processing units 340, 350, and 360. At this time, the MAC frame is output to the corresponding one or more of the wireless signal processing units 340, 350, and 360. Furthermore, the frame processing unit 330 extracts the LLC packet or the management information from the MAC frame input from each of the wireless signal processing units 340, 350, and 360. Then, the frame processing unit 330 Outputs the LLC packet to the LLC processing unit 310, and outputs the management information to the management unit 320.

In the terminal 30-1 in the example of FIG. 1, A-STA1-1, A-STA1-2, and A-STA1-3 which are affiliated STAS include wireless signal processing units 340, 350, and 360, respectively. In the terminal 30-2, the A-STA2-1, A-STA2-2, and A-STA2-3, which are affiliated STAs, include wireless signal processing units 340, 350, and 360, respectively. The wireless signal processing units 340, 350, and 360 have functional configurations equivalent to one another.

Each of the wireless signal processing units 340, 350, and 360 adds a preamble and the like to the MAC frame input from the frame processing unit 330 to generate a wireless frame. Then, each of the wireless signal processing units 340, 350, and 360 converts the generated wireless frame into a wireless signal, and transmits (radiates) the converted wireless signal via the antenna. Conversion processing from the wireless frame into the wireless signal is performed as described above.

Further, each of the wireless signal processing units 340, 350, and 360 converts the wireless signal received from the corresponding shared AP 20 via an antenna into the wireless frame. Conversion processing from the wireless signal into the wireless frame is performed as described above. Each of the wireless signal processing units 340, 350, and 360 extracts the MAC frame from the converted wireless frame, and outputs the extracted MAC frame to the frame processing unit 330.

In the communication system 1 of the multi-AP connection method as described above, there may be a plurality of terminals 30 that perform wireless communication via a plurality of links in an environment in which a plurality of shared APs 20 are used. In this case, a state may occur in which one or more shared APs 20 are a common connection destination of wireless connections of the plurality of terminals 30. For example, in the example of FIG. 1, in the plurality of terminals 30-1 and 30-2, connection destinations of wireless connection are the shared APs 20-1 to 20-3, and the three shared APs 20-1 to 20-3 are a common connection destination common to the plurality of terminals 30. At this time, in each of the Shared APs 20, a plurality of the shared APs 20 including the own station are in a common connection destination of wireless connections of the plurality of terminals 30. Then, each of the terminals 30 is wirelessly connected to the plurality of shared APs 20 as common connection destination of the plurality of terminals 30 including the own station, by the wireless signal processing units 340, 350, and 360.

Hereinafter, processing performed by the sharing AP 10, the shared AP 20, and the terminal 30 in a state where the plurality of shared APs 20 are a common connection destination common to the plurality of terminals 30 will be described. As illustrated in FIG. 1 and the like, a state in which the three shared APs 20-1 to 20-3 are a common connection destination of the plurality of terminals 30 will be described as an example. In the following description, a case where data is transferred from the Sharing AP 10 to the terminal 30 via any one of the shared APs 20, that is, a case where downlink data is transmitted will be described.

In a state in which the plurality of shared APs 20 are the common connection destination of the plurality of terminals 30, the management unit 120 of the sharing AP 10 cooperates with the management unit 210 or the like of the shared AP 20 to allocate a transfer period to the plurality of terminals 30 wirelessly connected to the common connection destination for each terminal 30. That is, a transfer period is set for each terminal 30 and each non-AP MLD. In each of the transfer periods, the terminal 30 to which the transfer period is allocated in real time is set as a single target terminal. In each transfer period, data (traffic) is transferred from the plurality of shared APs 20 which are the common connection destination only to a single target terminal, and only the target terminal performs data transfer with the plurality of shared APs 20 which are the common connection destination.

In each of the transfer periods, the terminals 30 Other than the target terminal, that is, the terminals 30 Other than the terminals 30 to which the transfer periods are allocated in real time do not perform data transfer with the plurality of shared APs 20 which are the common connection destination. The management unit 120 or the like allocates the transfer period to the plurality of terminals 30 in a state where the transfer periods do not temporally overlap among the plurality of terminals 30.

Therefore, the transfer period in which the plurality of shared APs 20 which are the common connection destination transfers data only to one terminal 30 is time-divided with respect to the transfer period in which the plurality of shared APs 20 transfers data only to another one terminal 30.

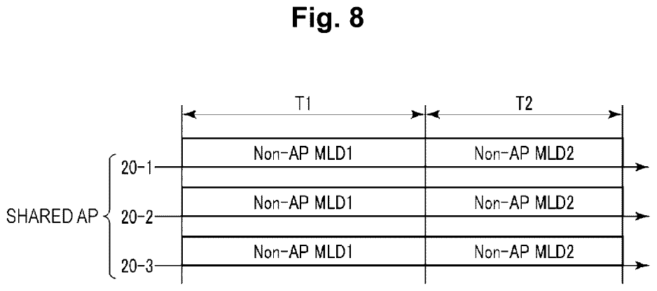

FIG. 8 is a sequence diagram illustrating an example of allocation of transfer periods to a plurality of terminals in the communication system according to the embodiment. In the example of FIG. 8, a connection similar to that in the example of FIG. 1 is established between each of the terminals 30 and the sharing AP 10. A transfer period T1 in which data is transferred only from the plurality of shared APs 20-1 to 20-3 to the terminal 30-1 (non-AP MLD 1) and a transfer period T2 in which data is transferred only from the plurality of shared APs 20-1 to 20-3 to the terminal 30-2 (non-AP MLD 2) are set. Then, the transfer period Tl is allocated to the terminal 30-1, and the transfer period T2 is allocated to the terminal 30-2.

In the transfer period T1, the terminal 30-1 is set as a single target terminal that performs data transfer with the shared APs 20-1 to 20-3, and the terminals 30-2 other than the target terminal does not perform data transfer with the shared APs 20-1 to 20-3. In the transfer period T2, the terminal 30-2 is set as a single target terminal that performs data transfer with the shared APs 20-1 to 20-3, and the terminal 30-1 other than the target terminal does not perform data transfer with the shared APs 20-1 to 20-3.

In the example of FIG. 8, the transfer period T2 allocated to the terminal 30-2 starts from the end of the transfer period T1 allocated to the terminal 30-1, and the transfer periods T1 and T2 do not overlap with each other in time. Then, at the time of switching from the transfer period T1 to the transfer period T2, the transfer periods T1 and T2 are time-divided with respect to each other.

In the example of FIG. 8, at the time of switching from the transfer period Tl to the transfer period T2, the terminal 30 to which the transfer period is allocated is switched from the terminal 30-1 to the terminal 30-2.

Then, in each of the plurality of shared APs 20-1 to 20-3 which are the common connection destination of the terminal 30, the counterpart of the data transfer is switched from the terminal 30-1 to the terminal 30-2 at the time of switching from the transfer period Tl to the transfer period T2. Therefore, for each of the shared APs 20-1 to 20-3, at the time of switching from the transfer period Tl to the transfer period T2, the period in which the destination of data transfer is the terminal 30-1 is time-divided with respect to the period in which the counterpart of data transfer is the terminal 30-2.

By allocating the transfer period to each terminal 30 (one non-AP MLD) as described above, in each transfer period, data transfer with the target terminal to which the transfer period is allocated is synchronized among the plurality of shared APs 20. That is, the periods in which data is transmitted to the target terminal are temporally aligned among the plurality of shared APs 20 which are the Common connection destination. In the example of FIG. 8, data transfer to the terminal 30-1 is performed in synchronization among a plurality of shared APs 20 in the transfer period Tl, and data transfer to the terminal 30-2 is performed in synchronization among a plurality of shared APs 20 in the transfer period T2.

In each of the transfer periods, the management unit 210 of each of the shared APs 20 cooperates with the Sharing AP 10, the other shared APs 20, and the like to synchronize data transfer to the target terminal to which the transfer period is allocated in real time in the own station and the other shared AP 20, that is, in the plurality of shared APs 20 which are common connection destination. Then, the management unit 320 of each of the terminals 30 cooperates with the sharing AP 10 and the plurality of shared APs 20 which are the common connection destination to synchronize data transfer to the own station, which is the target terminal, among the plurality of shared APs 20 which are the common connection destination in the transfer period allocated to the own station.

In addition, the management unit 120 of the sharing AP 10 switches the terminal 30 to which the transfer period is allocated in cooperation with the belonging shared AP 20 or the like, thereby synchronizing the timing when the terminal 30, which is the counterpart of the data transfer, is switched between the plurality of shared APs 20 which are the common connection destination. That is, in the plurality of shared APs 20, timings when the terminals 30, which are counterparts of the data transfer, are switched are temporally aligned. In the example of FIG. 8, the counterpart of the data transfer is switched from the terminal 30-1 to the terminal 30-2 at the time of switching from the transfer period T1 to the transfer period T2 in synchronization among the plurality of shared APs 20.

The management unit 210 of each of the shared APs 20 cooperates with the sharing AP 10, the other shared APs 20, and the like to switch the terminal 30 to which the transfer period is allocated, thereby synchronizing the timing when the terminals 30, which are counterparts of the data transfer, in the own station and the other shared AP 20, that is, in the plurality of shared APs 20 which are Common connection destination. The management unit 320 of each of the terminal 30 cooperates with the sharing AP 10, the plurality of shared APs 20 which are common connection destination to switch the terminal 30 to which the transfer period is allocated from own station, thereby synchronizing the timing when the terminals 30, which are counterparts of the data transfer, are switched from the own station in the plurality of shared APs 20 which are common connection destination.

When determining the allocation of the transfer periods to the plurality of terminals 30 wirelessly connected to the common connection destination, the management unit 120 of the sharing AP 10 monitors, in cooperation with the management unit 210 such as the shared AP 20, the status of the traffic to be transmitted to each of the terminals 30, the status of the terminal 30 which is the transfer target of data (traffic), and the like. As the traffic status, for example, any one of the traffic amount and the time required for transmission is measured for each piece of traffic to be transmitted. As the status of the terminal 30, for example, any one of the transmission air time, the number of frame transmissions, and the channel occupancy time is measured for each of the terminals 30 which are the data transfer target. Further, from the measured channel occupancy time and the like, the traffic amount during transmission standby in the terminal 30, the congestion degree of the traffic in the terminal 30, and the like may be detected as the status of the terminal 30.

In one example, a control device that bundles a plurality of sharing APs including the sharing AP 10 is provided, and the control device controls the traffic status and the like of each of the plurality of sharing APs including the sharing AP 10. In this case, the management unit 120 of the sharing AP 10 collects information regarding other sharing APs from the control device. The information regarding other sharing APs includes a traffic status in other sharing, a data transfer status between other sharing APs and the terminal 30, and the like. Then, the management unit 120 detects a status of the terminal 30 such as congestion of traffic in the terminal 30 on the basis of information or the like collected from the control device. In the present example, the management unit 120 may notify the belonging shared AP 20 of the information collected from the control device.

In the present embodiment, the above-described monitoring of the traffic to be transmitted and the status of the terminal 30 which is the transfer target or the like is performed by the management unit 120 or the like for a certain period of time. Then, the management unit 120 and the like determine the allocation of the transfer periods to the plurality of terminals 30 on the basis of the traffic and the status of the terminals 30 and the like detected by the monitoring. In one example, the allocation of the transfer period to the terminal 30 is determined on the basis of the channel occupancy time of each of the terminals 30 which are data transfer target. At this time, for example, the terminal 30 having a longer channel occupancy time is preferentially allocated with a transfer period.

When determining the allocation of the transfer periods to the plurality of terminals 30, the management unit 120 notifies the shared AP 20 and the terminal 30 of the allocation information regarding the determined transfer period. Then, the management units 320 of the plurality of terminals 30 and the management unit 210 of the shared AP 20 which is the common connection destination of the plurality of terminals 30 cooperate with each other and control the data transfer on the basis of the allocation information for the determined transfer period. As a result, in each transfer period, the plurality of shared APs 20 which are the common connection destination performs data transfer only with a single target terminal to which the transfer period is allocated. In each transfer period, the plurality of shared APs 20 may perform data transfer with the target terminal in a normal scheme or may perform data transmission using a burst mode.

The management unit 120 of the sharing AP 10 manages the transfer period for which the allocation has been determined. In one example, at the start of each transfer period, the management unit 120 notifies the start of the transfer period by transmitting a trigger to the terminal 30 to be the target terminal to which the transfer period is allocated. The trigger includes information regarding the end time of the transfer period to be started or the length of the transfer period to be started. Therefore, the terminal 30 to be the target terminal receives the trigger to acquire information regarding the end of the started transfer period. Accordingly, in the present example, the management unit 120 manages and controls the transfer period allocated to the plurality of terminals 30 by transmitting the trigger to the terminal 30 to be the target terminal at the start of each transfer period. The management unit 120 may manage and control the transfer period allocated to the plurality of terminals 30 by transferring the RTS/CTS signal, instead of the trigger, with the terminal 30 which is the target terminal.

In another example, the management unit 120 designates a period other than the transfer period as a network allocation vector (NAV) in advance for each of the plurality of terminals 30. In each of the plurality of terminals 30, the management unit 320 controls the data transfer such that the data transfer is not performed with the plurality of shared APs 20 which are the common connection destination in the period designated as the NAV. Accordingly, in the present example, the management unit 120 manages and controls the transfer period allocated to the plurality of terminals 30 by designating a period other than the transfer period as a transfer prohibition period in advance for each of the plurality of terminals 30.

In one example, the management unit 320 of each of the plurality of terminals 30 sets its own station to a sleep state in a period other than the allocated transfer period. In this case, the management unit 120 of the sharing AP 10 may notify each of the plurality of terminals 30 of a command to enter the sleep state in a period other than the transfer period by transmitting a trigger or the like.

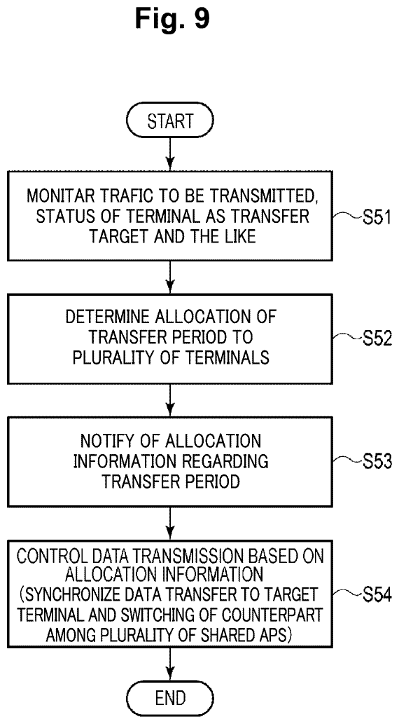

FIG. 9 is a flowchart illustrating an example of processing performed by the communication system according to the embodiment. The processing illustrated in the example of FIG. 9 is periodically performed in a state in which the plurality of shared APs 20 are a common connection destination of wireless connections of the plurality of terminals 30. When the processing of the example of FIG. 9 is started, the management unit 120 of the sharing AP 10 monitors, in cooperation with the management unit 210 such as the shared AP 20, the status of the traffic to be transmitted to each of the terminals 30, the status of the terminal 30 which is data transfer target, and the like (S51). Monitoring of the traffic Status, the status of the terminal 30, and the like is performed as described above.

Then, the management unit 120 and the like determine the allocation of the transfer periods to the plurality of terminals 30 wirelessly connected to the common connection destination on the basis of the traffic and the status of the terminals 30 and the like detected by the monitoring (S52). At this time, allocation of the transfer periods to the plurality of terminals 30 is determined as described above. Then, the management unit 120 notifies the shared AP 20 and the terminal 30 of the allocation information regarding the determined transfer period (S53).

Then, the management units 320 of the plurality of terminals 30 and the management unit 210 of the shared AP 20 which is the common connection destination of the plurality of terminals 30 cooperate with each other and control the data transfer on the basis of the allocation information for the determined transfer period (S54). As a result, in each transfer period, the plurality of shared APs 20 which are the common connection destination performs data transfer only with a single target terminal to which the transfer period is allocated. Then, in each transfer period, data transfer with a target terminal to which the transfer period is allocated is synchronized among the plurality of shared APs 20. In addition, timings when the terminals 30, which are counterparts of the data transfer, are switched are synchronized among the plurality of shared APs 20.

In the above-described example, the case where the data (downlink data) is transferred from the plurality of shared APs 20 to the target terminal in each transfer period has been described. However, the data (uplink data) may be transferred from the target terminal to which the transfer period is allocated to the plurality of shared APs 20 which are the common connection destination in each transfer period. Furthermore, in each transfer period, both transfer of data from the plurality of shared APs 20 to the target terminal and transfer of data from the target terminal to the plurality of shared APs 20 may be performed. However, in any case, the plurality of shared APs 20 which are the common connection destination of the plurality of terminals 30 performs data transfer only with a single target terminal to which the transfer period is allocated in each transfer period, and does not perform data transfer with terminals 30 other than the target terminal.

As described above, in the present embodiment, in a state in which the plurality of shared APs 20 are the common connection destination of the plurality of terminals 30, the transfer period in which only a single target terminal (single target terminal group) performs data transfer with the plurality of shared APs 20 which are the common connection destination is allocated to each terminal 30 (for each terminal group) to the plurality of terminals 30 wirelessly connected to the common connection destination. Then, in each transfer period, data transfer with the target terminal (target terminal group) to which the transfer period is allocated is synchronized among the plurality of shared APs 20 which are the common connection destination.

By controlling the data transfer as described above, in each of the plurality of terminals 30 wirelessly connected to the common connection destination, the timing Of the data transmission (data exchange) is prevented from being shifted for each of the shared AP 20 which is the Common connection destination. Therefore, in data transfer between the sharing AP 10 and each of the terminals 30, a decrease in throughput is suppressed and an increase in data transmission time is suppressed. In each of the transfer periods, the plurality of shared APs 20 which are the common connection destination perform data transfer only with the target terminal to which the transfer period is allocated, and thus, collision of uplink data transmitted from each of the terminals 30 with uplink data from another terminal 30 is effectively prevented.

In the present embodiment, by switching the terminal 30 to which the transfer period is allocated, the timing when the terminal 30, which is the counterpart of the data transfer, is switched is synchronized among the plurality of shared APs which are the common connection destination. As a result, in each of the plurality of terminals 30 wirelessly connected to the common connection destination, the timing of the data transfer (data exchange) is further effectively prevented from being shifted for each of the shared AP 20 which is the common connection destination.

In an example of the embodiment and the like, at the start of each transfer period, a trigger is transmitted to the terminal 30 to be the target terminal, or in each of the plurality of terminals 30, a period other than the transfer period is designated in advance as a NAV (transfer prohibition period). As a result, each of the plurality of terminals 30 performs data transfer with the shared AP 20 which is the common connection destination to a state corresponding to the allocation of the transfer period to the plurality of terminals 30.

In an example of the embodiment, each of the plurality of terminals 30 enters the sleep state in a period other than the transfer period. In the present embodiment, as described above, each of the plurality of terminals 30 performs data transfer with the plurality of shared APs 20 which are the common connection destination only in the allocated transfer period, and does not perform data transfer with the shared APs 20 in a period other than the transfer period. Therefore, even if the plurality of terminals 30 enter the sleep state in a period other than the transfer period, each of the plurality of terminals 30 appropriately performs data transfer with the plurality of shared APs 20 which are the common connection destination. Furthermore, by being in the sleep state in a period other than the transfer period, power consumption in each of the plurality of terminals 30 is suppressed.

Note that, in the above-described embodiment, a case where three affiliated STAs are provided in each of the terminals 30 has been mainly described. However, it is sufficient for the terminal 30 to have a configuration provided with a plurality of affiliated STAs. That is, in each of the terminals 30, two affiliated STAs may be provided, or four or more affiliated STAs may be provided.

In the above-described embodiment, a case where the shared APs 20-1 to 20-3 are the common connection destination of the wireless connections of the plurality of terminals 30 has been mainly described. However, also in a case where only two of the shared APs 20-1 to 20-3 are the common connection destination of the plurality of terminals 30, such as a case where only the shared APs 20-1 and 20-2 are the common connection destination of the plurality of terminals 30, as similar to the above-described embodiment and the like, the transfer period in which only a single target terminal (single target terminal group) performs data transfer with the plurality of shared APs 20 which are the common connection destination can be allocated to the plurality of terminals 30 wirelessly connected to the common connection destination for each terminal 30 (for each terminal group). Then, in each transfer period, data transfer with the target terminal to which the transfer period is allocated is synchronized among the plurality of shared APs 20 which are the common connection destination.

Also in a case where four or more shared APs 20 belong to the sharing AP 10 and the four or more shared APs 20 are a common connection destination of a plurality of terminals 30, allocation of transfer periods and data transfer in each of the transfer periods are performed in a similar manner to the above-described embodiment and the like.

In addition, in a case where only one shared AP 20 is the common connection destination of the plurality of terminals 30, such as a case where only the shared AP 20-1 is the common connection destination of the wireless connection of the plurality of terminals 30, the transfer period can be allocated to the plurality of terminals 30 wirelessly connected to the common connection destination, similarly to the above-described embodiment and the like.

Also in this case, as similar to the above-described embodiment and the like, a transfer period in which only a single target terminal (single target terminal group) performs data transfer with the shared AP 20 which is the common connection destination is allocated to the plurality of terminals 30 for each terminal 30. By allocating the transfer periods as described above, in data transfer between the sharing AP 10 and each of the terminals 30, a decrease in throughput is suppressed and an increase in data transmission time is suppressed.

Furthermore, in a modification, the plurality of terminals 30 wirelessly connected to the common connection destination are grouped into a plurality of terminal groups. One or more terminals 30 belong to each of the plurality of terminal groups. In the present modification, the transfer period is allocated to the plurality of terminals 30 wirelessly connected to the common connection destination for each terminal group. In each transfer period, only a single target terminal group performs data transfer with the shared AP 20 which is the common connection destination, and terminal groups other than the target terminal group cannot perform data transfer with the shared AP 20 which is the common connection destination.

In the present embodiment, in a case where a plurality of shared APs 20 exist as the common connection destination of the plurality of terminals 30, in each transfer period, data transfer with the target terminal group to which the transfer period is allocated is synchronized among the plurality of shared APs 20 which are the common connection destination. In addition, in a case where a plurality of shared APs 20 exist as the common connection destination of the plurality of terminals 30, by switching the terminal group to which the transfer period is allocated, the timing when the terminal 30, which is the counterpart of the data transfer, is switched is synchronized among the plurality of shared APs 20 which are the common connection destination. Also in the present modification, the same operations and effects as those of the above-described embodiment and the like are obtained.

In the modification in which the transfer period is allocated to each terminal group, the transfer period is allocated to each terminal 30 similarly to the above-described embodiment and the like by setting only one terminal 30 as the belonging terminal 30 in any of the plurality of grouped terminal groups. In addition, the plurality of terminals 30 wirelessly connected to the common connection destination are grouped in a state in which the deviation of the traffic amount among the plurality of terminal groups is as small as possible. In one example, the terminal 30 having a large traffic amount and the terminal 30 having a small traffic amount are grouped into states belonging to the same terminal group.

In the above embodiment, each of the plurality of terminals 30 wirelessly connected to the common connection destination corresponds to the non-AP MLD that establishes the wireless connection through the plurality of links.

However, the plurality of terminals 30 wirelessly connected to the common connection destination may include the terminal 30 that establishes the wireless connection through only one link. That is, the plurality of terminals 30 wirelessly connected to the common connection destination may include a non-MLD STA that is the terminal 30 including only one affiliated STA. The terminal 30 which is a non-MLD STA can establish wireless connection only with one shared AP 20. Even when the plurality of terminals 30 wirelessly connected to the common connection destination include non-MLD STAs, the transfer period is allocated to the plurality of terminals 30 wirelessly connected to the common connection destination for each terminal group. In each transfer period, only a single target terminal group performs data transfer with the shared AP 20 which is the common connection destination, and terminal groups other than the target terminal group Cannot perform data transfer with the shared AP 20 which is the common connection destination.

Furthermore, in the above-described embodiment, the function of the sharing AP and the function of the shared AP are completely divided, but in a modification, the sharing AP may have the function of the shared AP. For example, in a communication system 1 similar to FIG. 1 or the like, the sharing AP 10 may perform processing of the shared AP 20-1 in addition to the above-described processing. In this case, the sharing AP 10 includes the management unit 210, the frame processing unit 220, and the wireless signal processing unit 240 as a functional configuration in addition to the LLC processing unit 110, the management unit 120, the frame processing unit 130, and the transmission/reception unit 140.

In the sharing AP 10 having the function of the shared AP, the transmission/reception unit 140 transmits and receives the data, management information, and the like to and from each of the shared APs 20-2 and 20-3 that are the belonging shared APs 20 by the wireless communication or the wired communication. Then, in the sharing AP 10, the wireless signal processing unit 240 can transmit and receive the data, management information, and the like to and from each of the terminals 30-1 and 30-2 by the wireless communication. Furthermore, the data, management information, and the like are exchanged between the frame processing unit 130 included in the function of the sharing AP 10 and the frame processing unit 220 included in the function of the shared AP. Even in the case where the Sharing AP 10 having the function of the shared AP is provided, the sharing AP 10, the shared AP 20 belonging to the sharing AP 10, and the terminal 30 perform processing similar to the above-described embodiment and the like.

Furthermore, in the above-described embodiment and the like, in the connection between the sharing AP 10 and the terminal 30, the number of shared APs to pass through is one, but in a modification, the sharing AP 10 and the terminal 30 may be connected via two or more shared APs. That is, the processing of the above-described embodiment and the like can also be applied to a multi-AP connection method having a multistage configuration in which two or more shared APs are interposed between the sharing AP and the terminal.

Moreover, processing according to the above-described embodiment and the like can be stored as a program that can be executed by a processor that is a computer. Moreover, it is possible to store and distribute a program that executes the above-described processing in a storage medium of an external storage device such as a magnetic disk, an optical disk, or a semiconductor memory. Then, the processor reads the program stored in the storage medium of the external storage device, and the operation is controlled by the read program, whereby processing according to the embodiment or the like can be executed.

Note that the present invention is not limited to the above embodiments, and various modifications can be made in the implementation stage without departing from the gist of the invention. Moreover, embodiments may be implemented in appropriate combination, and in that case, a combined effect can be obtained. Further, the above embodiment includes various inventions, and various inventions can be extracted by a combination selected from the plurality of disclosed components. For example, in a Case where the problems can be solved and the effects can be obtained even if some components are deleted from all the components described in the embodiment, a configuration from which the components are deleted can be extracted as an invention.

### REFERENCE SIGNS LIST

1 Communication system
10 Sharing AP
11, 21, 31 CPU
12, 22, 32 ROM
13, 23, 33 RAM
14, 24, 34 Wireless communication module
15 Wired communication module
20, 20-1, 20-2, 20-3 Shared AP
30, 30-1, 30-2 Terminal
35 Display
36 Storage
40 Network
110, 310 LLC processing unit
120, 210, 320 Management unit
121 Multi-AP management information
122 Terminal management information
130, 220, 330 Frame processing unit
140, 230 Transmission/reception unit
211, 321 Link management information
240, 340, 350, 360 Wireless signal processing unit
300 Application execution unit

1. A sharing access point comprising processing circuitry configured to allocate, in a state in which one or more shared access points are a common connection destination of wireless connection of a plurality of terminals, a transfer period in which only a single target terminal group performs data transfer with the shared access point which is the common connection destination, to the plurality of terminals grouped into a plurality of terminal groups for each terminal group.

2. The sharing access point according to claim 1, wherein, in a case where a plurality of shared access points exist as the common connection destination of the plurality of terminals, the processing circuitry is configured to synchronize data transfer with the target terminal group to which the transfer period is allocated in the transfer period among the plurality of shared access points which are the common connection destination.

3. The sharing access point according to claim 1, wherein, in a case where a plurality of shared access points exist as the common connection destination of the plurality of terminals, the processing circuitry is configured to synchronize a timing when a terminal, which is a counterpart of data transfer, is switched among the plurality of shared access points, which are the common connection destination, by switching a terminal group to which the transfer period is allocated.

4. A shared access point comprising processing circuitry configured to allocate, in a state in which one or more shared access points belonging to a sharing access point including own station are a common connection destination of wireless connection of a plurality of terminals, a transfer period in which only a single target terminal group performs data transfer with the shared access point which is the common connection destination, to a plurality of terminals grouped into a plurality of terminal groups for each terminal group.

5. The shared access point according to claim 4, wherein, in a case where a plurality of shared access points including own station exist as the common connection destination of the plurality of terminals, the processing circuitry is configured to synchronize data transfer with the target terminal group to which the transfer period is allocated in the transfer period among the plurality of shared access points which are the common connection destination.

6. The shared access point according to claim 4, wherein, in a case where a plurality of shared access points including own station exist as the common connection destination of the plurality of terminals, the processing circuitry is configured to synchronize a timing when a terminal, which is a counterpart of data transfer, is switched among the plurality of shared access points, which are the common connection destination, by switching a terminal group to which the transfer period is allocated.

7. A terminal comprising:
a wireless signal processing circuit; and
processing circuitry configured to allocate, in a state of being wirelessly connected by the wireless signal processing circuit to one or more shared access points belonging to a sharing access point as a common connection destination of a plurality of terminals including own station, a transfer period in which only a single target terminal group among the plurality of terminals grouped into a plurality of terminal groups performs data transfer with the shared access point which is the common connection destination, to a terminal group to which own station belongs.

8. A terminal according to claim 7, wherein, in a case where a plurality of shared access points exist as the common connection destination of the plurality of terminals including own station, the processing circuitry is configured to synchronize data transfer with the target terminal group among the plurality of shared access points which are the common connection destination, in the transfer period allocated to the terminal group to which own station belongs.
